(19) United States
(12) Patent Application Publication
(10) Pub. No.: US 2024/0359266 A1
(43) Pub. Date: Oct. 31, 2024

(54) LASER PROCESSING MACHINE AND LASER PROCESSING METHOD

(71) Applicant: DISCO CORPORATION, Tokyo (JP)

(72) Inventors: Yuji HADANO, Tokyo (JP); Keiji NOMARU, Tokyo (JP)

(21) Appl. No.: 18/626,632

(22) Filed: Apr. 4, 2024

(30) Foreign Application Priority Data
Apr. 25, 2023 (JP) 2023-071481

(51) Int. Cl. B23K 26/364; B23K 26/70

(52) U.S. Cl. CPC B23K 26/364; B23K 26/702

(57) ABSTRACT

A laser processing machine for forming grooves or perforations in a workpiece from its one side includes a holding unit that holds the workpiece at the other side to have the one side exposed, a laser irradiation unit having a laser oscillator that emits a laser beam and a condenser that concentrates the laser beam and irradiates the workpiece with the concentrated laser beam, and a liquid ejection nozzle that ejects liquid to an irradiation region where the workpiece is to be irradiated with the concentrated laser beam on its one side, to form a thin film of the liquid. The workpiece is irradiated with the concentrated laser beam through the thin film of the liquid. A laser processing method is also disclosed.

### BACKGROUND OF THE INVENTION

### Field of the Invention

The present invention relates to a laser processing machine, and also to a laser processing method.

### Description of the Related Art

As a method for dividing a wafer such as a semiconductor wafer or an optical device wafer along scribe lines, there has been proposed a method that irradiates the wafer with a laser beam of a wavelength having absorptivity for the wafer, along scribe lines to form laser processed grooves or laser processed perforations through ablation processing, and then breaks off individual device chips with use of the laser processed grooves or laser processed perforations as start points.

When a wafer is irradiated with a laser beam in such a method, debris occurs from irradiated regions, thereby causing a problem that the debris sticks surfaces of devices to lower their quality. To eliminate this problem, there has been proposed a laser processing machine that forms a layer of liquid over an upper surface of a wafer and irradiates the wafer with a laser beam through the layer of the liquid thus formed (JP 2016-036818A).

### SUMMARY OF THE INVENTION

When the wafer is irradiated with a leading laser beam through the layer of the liquid, however, fine bubbles are generated from sites irradiated with the leading laser beam. By the bubbles, a trailing laser beam is scattered, and the surfaces of devices in the wafer are irradiated with scattered light. There is hence a problem that the devices are lowered in quality.

The present invention therefore has as an object thereof the provision of a laser processing machine and a laser processing method which, when a workpiece is irradiated with a laser beam through a layer of liquid formed over an upper surface of the workpiece, can suppress lowering of the quality of devices by light scattered due to generated bubbles.

In accordance with an aspect of the present invention, there is provided a laser processing machine for forming grooves or perforations in a workpiece from one side thereof. The laser processing machine includes a holding unit that holds the workpiece at the other side thereof opposite to the one side to have the one side exposed, a laser irradiation unit having a laser oscillator that emits a laser beam and a condenser that concentrates the laser beam and irradiates the workpiece with the concentrated laser beam, and a liquid ejection nozzle that ejects liquid to an irradiation region where the workpiece is to be irradiated with the concentrated laser beam on the one side thereof, to form a thin film of the liquid over the irradiation region. The workpiece is irradiated with the concentrated laser beam through the thin film of the liquid.

Preferably, the liquid ejection nozzle may have an ejection diameter of 100 μm or smaller to eject the liquid. More preferably, the liquid ejection nozzle may have an ejection diameter of 50 μm or greater and 100 μm or smaller.

In accordance with another aspect of the present invention, there is provided a laser processing method for forming grooves or perforations in a workpiece from one side thereof. The laser processing method includes a holding step of holding the workpiece at the other side thereof opposite to the one side to have the one side exposed, a liquid thin film forming step of ejecting liquid to the one side of the workpiece to form a thin film of the liquid, and a laser beam irradiation step of emitting a laser beam, concentrating the laser beam, and then irradiating the workpiece at the one side thereof with the concentrated laser beam through the thin film of the liquid.

Preferably, the thin film of the liquid may be formed with a thickness of 100 μm or smaller in the liquid thin film forming step. More preferably, the thin film of the liquid may be formed with a thickness of 50 μm or greater and 100 μm or smaller.

According to the present invention, it is possible to suppress lowering of the quality of devices by scattered light due to bubbles generated, when the workpiece is irradiated with the concentrated laser beam through the layer of the liquid formed over the irradiation region of the workpiece.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view depicting a configuration example of a laser processing machine according to an embodiment of the present invention;

FIG. 2 is a perspective view depicting an example of a workpiece to be processed by the laser processing machine of FIG. 1;

FIG. 3 is a diagram illustrating a schematic configuration of a laser irradiation unit in the laser processing machine of FIG. 1;

FIG. 4 is a cross-sectional view depicting an example of a liquid ejection nozzle in the laser processing machine of FIG. 1;

FIG. 5 is an exploded cross-sectional view of the liquid ejection nozzle of FIG. 4;

FIG. 6 is a flow chart illustrating a flow of a laser processing method according to the embodiment;

FIG. 7 is a fragmentary cross-sectional view depicting an irradiation region in a laser beam irradiation step of the laser processing method of FIG. 6;

FIG. 8 is a fragmentary cross-sectional view depicting an irradiation region in the related art as a comparative example;

FIG. 9 contains images presenting empirical results on a laser processed groove and scattered light damages corresponding to varied pressures at the liquid ejection nozzle;

FIG. 10 contains an image presenting empirical results on a laser processed groove and scattered light damages corresponding to an ejection diameter (diameter: 100 μm) of the liquid ejection nozzle;

FIG. 11 contains an image presenting empirical results on a laser processed groove and scattered light damages corresponding to another ejection diameter (diameter: 50 μm) of the liquid ejection nozzle; and

FIG. 12 contains images presenting empirical results on a laser processed groove and scattered light damages when the thickness of a film of liquid was set to 3 mm, 2 mm, and 1 mm in the related art as the comparative example.

### DETAILED DESCRIPTION OF THE PREFERRED EMBODIMENT

With reference to the attached drawings, a description will be made in detail regarding an embodiment of the present invention. However, the present invention should not be limited by details that will be described in the following embodiment. The elements of configurations that will hereinafter be described include those readily conceivable by persons skilled in the art and substantially the same ones. Further, the configurations that will hereinafter be described can be combined appropriately. Moreover, various omissions, replacements, and modifications of the configurations can be made without departing from the spirit of the present invention.

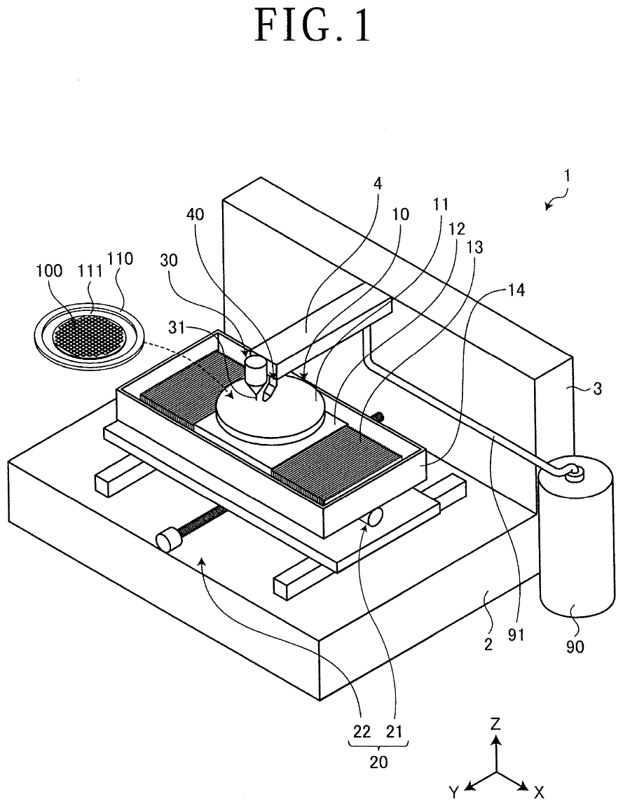

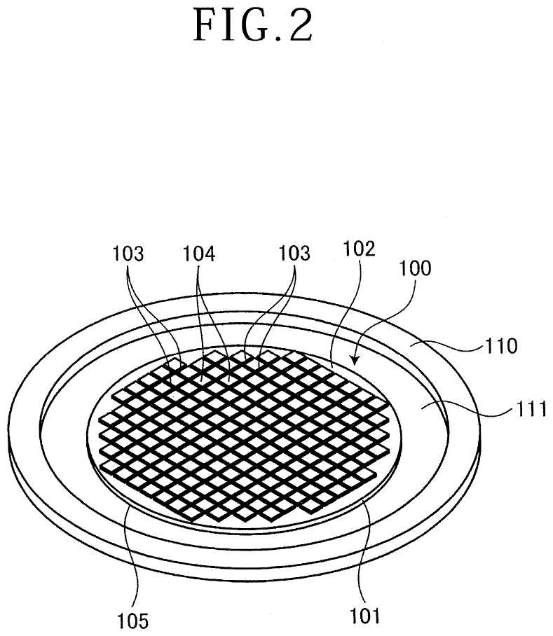

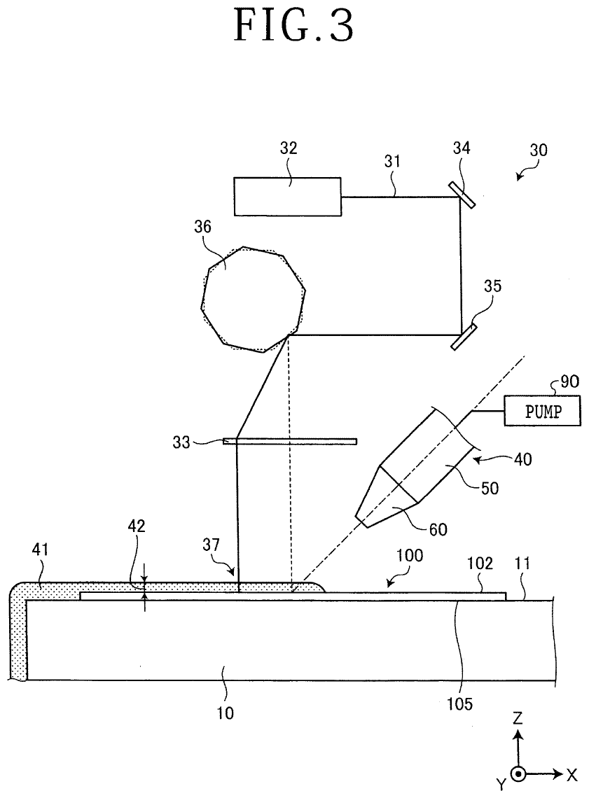

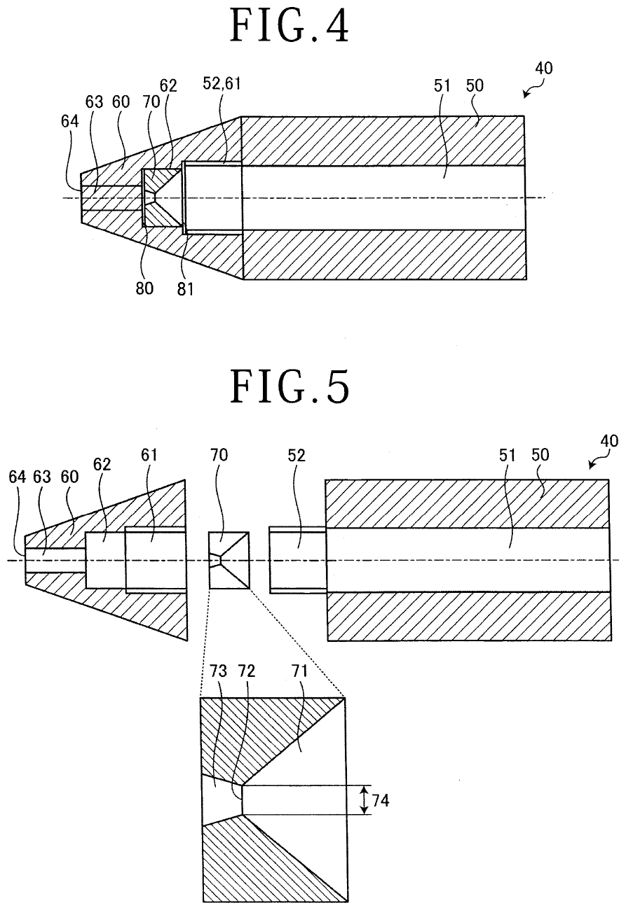

With reference to FIGS. 1 to 5, a description will first be made regarding configurations of a laser processing machine 1 according to the embodiment of the present invention. FIG. 1 is a perspective view depicting a configuration example of the laser processing machine 1 according to this embodiment. FIG. 2 is a perspective view depicting an example of a workpiece 100 to be processed by the laser processing machine 1. FIG. 3 is a diagram illustrating a schematic configuration of a laser irradiation unit 30 in the laser processing machine 1. FIG. 4 is a cross-sectional view depicting an example of a liquid ejection nozzle 40 in the laser processing machine 1. FIG. 5 is an exploded cross-sectional view of the liquid ejection nozzle 40 depicted in FIG. 4.

In the following description, an X-axis direction is a direction in a horizontal plane. A Y-axis direction is orthogonal to the X-axis direction in the horizontal plane. A Z-axis direction is orthogonal to the X-axis direction and the Y-axis direction. In the laser processing machine 1 of this embodiment, a processing feed direction extends along the X-axis direction, and an indexing feed direction extends along the Y-axis direction.

As depicted in FIG. 1, the laser processing machine 1 includes a holding unit 10, a moving unit 20, the laser irradiation unit 30, the liquid ejection nozzle 40, and a pump 90. The laser processing machine 1 according to this embodiment performs processing to form grooves or perforations from one side of the workpiece 100 which is held on the holding unit 10, through irradiation of the workpiece 100 with a pulsed laser beam 31 by the laser irradiation unit 30.

The workpiece 100 to be processed is a wafer such as a disk-shaped semiconductor wafer or an optical device wafer made using, as a substrate 101, for example, silicon (Si), silicon carbide (SiC), gallium nitride (GaN), gallium arsenide (GaAs), or another semiconductor material. As an alternative, the workpiece 100 is a disk-shaped wafer using, as the substrate 101, a material such as sapphire (Al₂O₃), glass, or quartz. Examples of the glass include alkali glass, alkali-free glass, soda-lime glass, lead glass, borosilicate glass, quartz glass, and so on. Described specifically, the workpiece 100 in this embodiment is a silicon wafer having a thickness of 350 μm.

As depicted in FIG. 2, the workpiece 100 has a plurality of scribe lines 103 set in a grid pattern on a front surface 102 of the substrate 101 and devices 104 formed in regions defined by the scribe lines 103. The devices 104 are, for example, integrated circuits such as general integrated circuits (ICs) or large-scale integration (LSI) circuits, image sensors such as charge coupled device (CCD) image sensors or complementary metal oxide semiconductors (CMOS) image sensors, micro electro mechanical systems (MEMS), or the like.

The workpiece 100 is provided with, for example, a tape 111 bonded to a back surface 105 of the workpiece 100. The tape 111 has a diameter greater than an outer diameter of the workpiece 100, and carries an annular frame 110 bonded thereto. The workpiece 100 is supported in an opening of the annular frame 110 via the tape 111, and is transferred and processed. The workpiece 100 is divided into the individual devices 104 along the scribe lines 103, and is hence singulated into chips. It is to be noted that the workpiece 100 is not limited to the disk shape, and may have another plate shape as a resin package substrate, a metal substrate, or the like. It is also to be noted that the chips are not limited to a square shape, and may also have a rectangular shape or another polygonal shape.

The holding unit 10 depicted in FIG. 1 is a table that holds the workpiece 100 on a holding surface 11. The holding unit 10 supports, for example, a side of the back surface 105 of the workpiece 100 such that the workpiece 100 is exposed on a side of the front surface 102. The holding surface 11 is a disk-shaped plate formed from a porous ceramic material or the like. In this embodiment, the holding surface 11 is a flat surface parallel to a horizontal direction. The holding surface 11 is connected, for example, to a vacuum suction source through a vacuum suction conduit. The holding unit 10 holds by suction the workpiece 100 placed on the holding surface 11.

Around the holding unit 10, a plurality of undepicted clamp portions are arranged to hold the annular frame 110 on which the workpiece 100 is supported. Further, the holding unit 10 is supported by an undepicted rotating unit rotatably about an axis of rotation parallel to the Z-axis direction. The holding unit 10 is covered at a lower portion thereof by a table cover 12 that is attached to an outer peripheral surface of the undepicted rotating unit.

On opposite sides in the X-axis direction of the table cover 12, a pair of bellows members 13 covering a processing feed unit 21 of the below-described moving unit 20 is disposed. The bellows members 13 have flexibility, are stretchable in the X-axis direction, and allow the table cover 12, in other words, the holding unit 10, to move in the X-axis direction. The bellows members 13 restrict liquid 41 and debris 108, which will be described subsequently herein, and the like from sticking the processing feed unit 21 and the like.

The holding unit 10, the table cover 12, and the bellows members 13 are accommodated and disposed inside a liquid catch pan 14. The liquid catch pan 14 is fixed on a below-described processing feed unit 21, which is fixedly disposed on a moving base of a below-described indexing feed unit 22. The liquid catch pan 14 includes a bottom plate, a plurality of side plates disposed upright from outer edges of the bottom plate, and a drain hole opening in the bottom plate. The drain hole is connected to an undepicted drainpipe, and discharges used liquid accumulated on the bottom plate.

The moving unit 20 moves the holding unit 10 and the laser irradiation unit 30 relative to each other. The moving unit 20 in this embodiment moves the holding unit 10, the table cover 12, and the undepicted rotating unit in the X-axis direction and the Y-axis direction relative to a machine main body 2. The moving unit 20 includes the processing feed unit 21 and the indexing feed unit 22.

The processing feed unit 21 moves the holding unit 10 and the laser irradiation unit 30 relative to each other in the X-axis direction as the processing feed direction. In this embodiment, the processing feed unit 21 moves the holding unit 10, the table cover 12, and the undepicted rotating unit in the X-axis direction. The processing feed unit 21 is arranged on the indexing feed unit 22 in this embodiment.

The processing feed unit 21 includes, for example, an undepicted moving base, undepicted guide rails supporting the moving base movably in the X-axis direction, an undepicted ball screw that extends in the X-axis direction along the guide rails and that is joined to the moving base via an undepicted nut portion, and a pulse motor that rotates the ball screw. On the moving base, an undepicted rotating unit is fixedly disposed. The ball screw and the guide rails are fixedly disposed on the moving base of the indexing feed unit 22.

The indexing feed unit 22 moves the holding unit 10 and the laser irradiation unit 30 relative to each other in the Y-axis direction as the indexing feed direction. In this embodiment, the indexing feed unit 22 moves the holding unit 10, the table cover 12, the undepicted rotating unit, and the processing feed unit 21 in the Y-axis direction. The indexing feed unit 22 is arranged on the machine main body 2 of the laser processing machine 1 in this embodiment.

The indexing feed unit 22 includes, for example, the moving base, undepicted guide rails supporting the moving base movably in the Y-axis direction, a ball screw extending in the X-axis direction along the guide rails and joined to the moving base via an undepicted nut portion, and a pulse motor that rotates the ball screw. On the moving base, an undepicted rotating unit is fixedly disposed. The ball screw and the guide rails are fixedly disposed on the machine main body 2.

The laser irradiation unit 30 irradiates the workpiece 100 held on the holding unit 10 with the pulsed laser beam 31. As depicted in FIG. 3, the laser irradiation unit 30 includes a laser oscillator 32, a condenser 33, mirrors 34 and 35, and a polygonal mirror 36.

The laser oscillator 32 emits the laser beam 31 having a predetermined wavelength suited for processing the workpiece 100. The laser beam 31 emitted by the laser irradiation unit 30 may be a laser beam of a wavelength having transmissivity for the workpiece 100, or may be a laser beam of a wavelength having absorptivity for the workpiece 100.

The condenser 33 concentrates the laser beam 31 emitted from the laser oscillator 32, and irradiates the workpiece 100 held on the holding surface 11 of the holding unit 10 with the concentrated laser beam 31. In this embodiment, the condenser 33 concentrates the laser beam 31 guided by the mirrors 34 and 35 and the polygonal mirror 36, such that the front surface 102 of the workpiece 100 held on the holding surface 11 of the holding unit 10 is irradiated with the concentrated laser beam 31.

The condenser 33 in this embodiment includes an fθ lens. The fθ lens is a combined lens in which two or more lenses are combined. The condenser 33 concentrates the laser beam 31 scanned in the X-axis direction by the below-described polygonal mirror 36, such that the workpiece 100 held on the holding surface 11 of the holding unit 10 is irradiated in the X-axis direction with the concentrated laser beam 31. A traveling direction of the concentrated laser beam 31 from the condenser 33 is parallel to the Z-axis direction.

In the laser irradiation unit 30, at least the condenser 33 is supported movably in the Z-axis direction by undepicted focal point position control means arranged on a vertical wall portion 3 (see FIG. 1) disposed upright from the machine main body 2 (see FIG. 1) of the laser processing machine 1. The focal point position control means moves the focal point of the laser beam 31 which has been concentrated by the condenser 33, in a direction of an optical axis (Z-axis direction) perpendicular to the holding surface 11 of the holding unit 10.

The mirrors 34 and 35 are arranged on an optical path of the laser beam 31 between the laser oscillator 32 and the condenser 33. The mirrors 34 and 35 guide the laser beam 31 which has been emitted from the laser oscillator 32, from the laser oscillator 32 to the condenser 33. If the laser beam 31 emitted from the laser oscillator 32 is an ultraviolet (UV) laser, for example, reflection coatings that reflect the UV laser are formed on the mirrors 34 and 35, respectively. In this embodiment, the mirror 34 reflects, toward the mirror 35, the laser beam 31 emitted from the laser oscillator 32. The mirror 35 reflects, toward the polygonal mirror 36, the laser beam 31 reflected by the mirror 34.

The polygonal mirror 36 is disposed on the optical path between the laser oscillator 32 and the condenser 33. The polygonal mirror 36 scans the laser beam 31 which has been emitted from the laser oscillator 32 and guided by the mirrors 34 and 35, in the X-axis direction as the processing feed direction of the moving unit 20 (see FIG. 1), and guides it to the condenser 33. The polygonal mirror 36 is a polygonal prism body (octagonal prism body in this embodiment) which has a flat mirror surface on each side surface thereof and also has an axis of rotation parallel to the Y-axis direction as the indexing feed direction. The condenser 33 has a front focal point at which the mirror surfaces on the respective side surfaces of the polygonal mirror 36 are to be sequentially positioned concurrently with impingement of the laser beam 31 thereon.

The polygonal mirror 36 has an axle held on an undepicted mirror holder such that the polygonal mirror 36 is rotatable or pivotal about an axis of rotation or pivoting by a rotary drive force outputted from an undepicted scan motor. The polygonal mirror 36 reflects the impinged laser beam 31 in a direction parallel to an XZ plane toward the condenser 33, and, owing to the rotation about the axis of rotation parallel to the Y-axis direction, also causes the laser beam 31 to scan in the X-axis direction. The laser beam 31 which has been caused to scan in the X-axis direction by the polygonal mirror 36 is concentrated by the condenser 33, is allowed to travel in a direction parallel to the Z-axis direction, and is applied to an irradiation region 37 of the workpiece 100.

The liquid ejection nozzle 40 ejects the liquid 41 to the irradiation region 37 which is to be irradiated with the concentrated laser beam 31, on the side of the one side (the front surface 102 in this embodiment) of the workpiece 100 held on the holding surface 11 of the holding unit 10, and forms a thin film of the liquid 41 over the irradiation region 37. The liquid 41 is, for example, water having been subjected to antifoaming treatment, pure water mixed with a defoaming agent, pure water having passed through a degassing filter (degassed water), chilled water, or the like. An example of the water having been subjected to antifoaming treatment is “FLUORINERT (registered trademark) FC-43” (product of 3M Japan Limited), which has a boiling point of 174° C., has a low surface tension, and is prone to collapse. The term “chilled water” means, for example, water of approximately 5° C. or lower. The liquid ejection nozzle 40 is disposed, for example, at a location adjacent to a processing head of the laser irradiation unit 30, the processing head having an emission hole through which the concentrated laser beam 31 is emitted, and in a posture inclined at a predetermined angle in the processing feed direction (X-axis direction) with respect to the optical path of the concentrated laser beam 31.

As depicted in FIGS. 4 and 5, the liquid ejection nozzle 40 has a base portion 50, a tip portion 60, an ejection diameter control member 70, and O-rings 80 and 81, and can be disassembled into the individual components. The base portion 50 has a cylindrical shape inside of which a flow passage 51 is formed along an axial direction to allow passage of the liquid 41 therethrough, and is communicated at an upstream side end portion thereof to the pump 90 (see FIG. 1) through a supply pipe 91 (see FIG. 1). The base portion 50 has a joint portion 52 at a downstream side end portion thereof. The joint portion 52 is formed with a diameter smaller than that of the remaining portion, and has external threads formed on an outer peripheral surface thereof.

The tip portion 60 has a truncated conical shape inside of which a through-hole extends along the axial direction. The through-hole of the tip portion 60 is divided into a joint portion 61, an ejection diameter control portion 62, and an ejection portion 63 from a side of a large diameter portion toward a side of a small diameter portion. The joint portion 61 has internal threads in an inner peripheral surface thereof, and is brought into threated engagement with the joint portion 52 of the base portion 50. By the threaded engagement of the joint portion 61 with the joint portion 52, the tip portion 60 is secured on the base portion 50.

The ejection diameter control portion 62 is a portion in which the ejection diameter control member 70 is accommodated. The ejection portion 63 is a portion located most downstream in the liquid ejection nozzle 40, and allows ejection of the liquid 41 from an orifice 64 at a downstream end. The ejection portion 63 has an inner diameter smaller than those of the joint portion 61 and the ejection diameter control portion 62.

The ejection diameter control member 70 is a jig which controls an ejection diameter 74 of the liquid 41 to be ejected from the liquid ejection nozzle 40 by constricting a flow of the liquid 41 to be supplied from a side of the flow passage 51. The ejection diameter control member 70 has a cylindrical shape having an internal through-hole along the axial direction. The ejection diameter control member 70 can be inserted from a side of the joint portion 61, and can be accommodated in the ejection diameter control portion 62.

The through-hole of the ejection diameter control member 70 is divided into a gradually constricted portion 71, a throat portion 72, and a gradually flaring portion 73 from the side of the joint portion 61 toward a side of the ejection portion 63 in a state in which the ejection diameter control member 70 is accommodated in the ejection diameter control portion 62. The gradually constricted portion 71 has a tapered inner wall formed such that its diameter gradually decreases toward the throat portion 72. The throat portion 72 is a portion having a smallest diameter in the through-hole of the ejection diameter control member 70, and has an inner diameter as the ejection diameter 74 of the liquid ejection nozzle 40.

The gradually flaring portion 73 has a flaring inner wall formed such that its diameter gradually increases toward the ejection portion 63. The gradually flaring portion 73 has a flaring angle smaller than a tapered angle of the gradually constricted portion 71. Further, the gradually flaring portion 73 has, at a downstream end thereof, an inner diameter which is the same as the inner diameter of the ejection portion 63 or, as depicted in FIGS. 4 and 5, is smaller than the inner diameter of the ejection portion 63.

With the ejection diameter control member 70 accommodated in the ejection diameter control portion 62 and the base portion 50 and the tip portion 60 threadedly engaged with each other at the joint portions 52 and 61, the liquid ejection nozzle 40 controls the liquid 41 which has been supplied from the side of the flow passage 51, to set the diameter of the liquid 41 to be the ejection diameter 74, and allows the liquid 41 to be ejected from the orifice 64.

As depicted in FIG. 4, the O-ring 80 that prevents leakage of the liquid 41 is fitted between a downstream side end portion of the ejection diameter control portion 62 and the ejection diameter control member 70 when the ejection diameter control member 70 is accommodated in the ejection diameter control portion 62. As also depicted in FIG. 4, the O-ring 81 that prevents leakage of the liquid 41 is fitted between a downstream side end portion of the joint portion 61 and the joint portion 52 when the base portion 50 and the tip portion 60 are brought into threaded engagement at the joint portions 52 and 61.

The pump 90 depicted in FIGS. 1 and 3 supplies the liquid 41 under pressure to the liquid ejection nozzle 40 through the supply pipe 91. The pump 90 may control the pressure at which the liquid 41 is to be supplied.

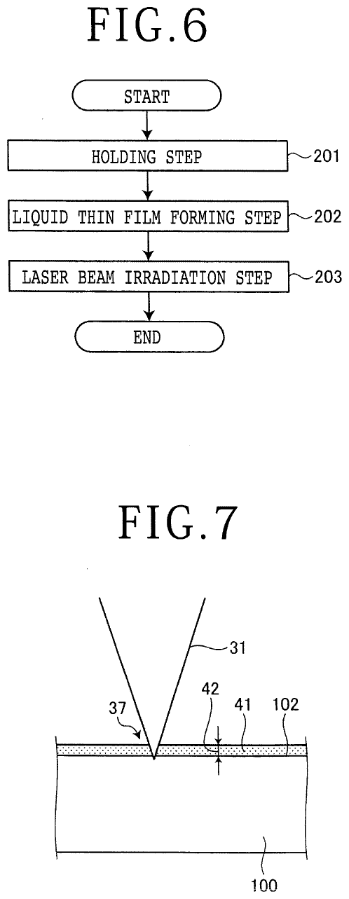

With reference to FIGS. 6 and 7, a description will next be made regarding a laser processing method according to the embodiment of the present invention. FIG. 6 is a flow chart illustrating a flow of the laser processing method according to this embodiment. Using the laser processing machine 1 depicted in FIGS. 1 to 5 and some other equipment, the laser processing method performs processing to form grooves or perforations from the one side of the workpiece 100 by irradiating the workpiece 100 with the concentrated laser beam 31. The laser processing method includes a holding step 201, a liquid thin film forming step 202, and a laser beam irradiation step 203.

The holding step 201 holds the workpiece 100 at the other side, which is on the side opposite to the one side to be irradiated with the laser beam 31, to have the one side exposed. In the holding step 201 in this embodiment, the side of the back surface 105 of the workpiece 100, as depicted in FIG. 3, is held on the holding surface 11 of the holding unit 10 such that the side of the front surface 102 is exposed.

Described specifically, the workpiece 100 held on the annular frame 110 and the tape 111 (see FIG. 2) is first transferred onto and placed on the holding surface 11 of the holding unit 10 by an undepicted transfer unit or the like. Next, a negative pressure is produced at the holding surface 11 of the holding unit 10 to draw the side of the back surface 105 of the workpiece 100 by suction, and at the same time, the annular frame 110 is held by the undepicted clamp portions, whereby the workpiece 100 is held by suction on the holding surface 11.

The liquid thin film forming step 202 ejects the liquid 41 to the one side of the workpiece 100, the one side being to be irradiated with the concentrated laser beam 31, to form a thin film of the liquid 41. In the liquid thin film forming step 202 in this embodiment, the liquid 41, as depicted in FIG. 3, is ejected by the liquid ejection nozzle 40 toward the irradiation region 37 on the side of the front surface 102 of the workpiece 100, whereby the thin film of the liquid 41 is formed over an area which contains the irradiation region 37, on the side of the front surface 102 of the workpiece 100.

In the liquid thin film forming step 202, the thin film of the liquid 41 is preferably formed with a thickness 42 of 50 μm or greater and 100 μm or smaller. Further, the distance in the axial direction (a direction indicated by an alternate long and short dash line in FIG. 3) from the orifice 64 (see FIGS. 4 and 5) of the liquid ejection nozzle 40 to the front surface 102 of the workpiece 100 is preferably 1 mm or greater and 10 mm or smaller. In addition, it is preferred to set the ejection diameter 74 (see FIG. 5) of the liquid ejection nozzle 40 to 50 μm or greater and 100 μm or smaller in diameter and set the nozzle pressure at 0.9 MPa or higher and 1.5 MPa or lower (gauge pressure), with 0.9 MPa or higher and 1.0 MPa or lower being more preferred. It is to be noted that these settings may preferably be adjusted appropriately. If the distance in the axial direction from the liquid ejection nozzle 40 to the front surface 102 of the workpiece 100 is increased, the nozzle pressure is raised such that the thickness 42 of the thin film of the liquid 41 falls in a range of 50 to 100 μm.

FIG. 7 is a fragmentary cross-sectional view depicting the irradiation region 37 in the laser beam irradiation step 203 illustrated in FIG. 6. The laser beam irradiation step 203 irradiates the one side of the workpiece 100 with the concentrated laser beam 31 through the thin film of the liquid 41. Here, a description will be made regarding a case in which processing of a straight groove is performed by linearly irradiating the one side of the workpiece 100 with the concentrated laser beam 31 in the processing feed direction, although the laser processing method of this embodiment may also be applied, for example, to processing of an annular groove.

In the laser beam irradiation step 203, as depicted in FIG. 3, with a continued supply of the liquid 41 from the liquid ejection nozzle 40, the laser irradiation unit 30 is operated, and at the same time, the processing feed unit 21 is operated, whereby the holding unit 10 is moved at a predetermined feed rate in the processing feed direction (X-axis direction). When the workpiece 100 is irradiated with the concentrated laser beam 31 in this embodiment, the position and the angle of the mirror surface on each side surface of the polygonal mirror 36 depicted in FIG. 3 change as the polygonal mirror 36 rotates. As a consequence, the workpiece 100 is irradiated and scanned in the X-axis direction with the concentrated laser beam 31.

Laser processing conditions in the laser beam irradiation step 203 in this embodiment are, for example, as described below.
Wavelength of laser beam: 355 nm
Repetition frequency: 5 MHz
Average power: 10 W
Processing feed rate: 50 mm/s
Mirror rotation speed: 5,000 rpm

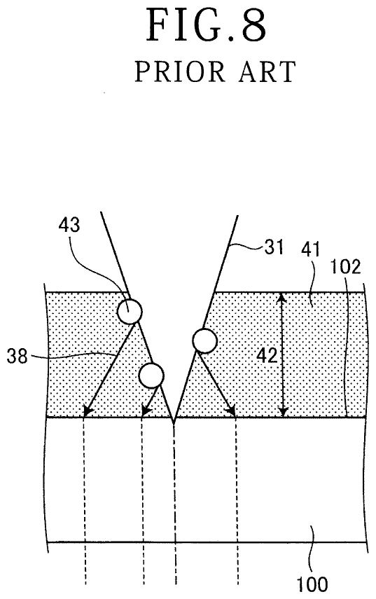

As depicted in FIG. 7, the laser beam 31 which has been concentrated through and emitted from the condenser 33 is allowed to transmit through the liquid 41, and is applied to the irradiation region 37 on the front surface 102 of the workpiece 100. Here, it is preferred to sufficiently reduce the thickness 42 of the thin film of the liquid 41, because the rising distance of bubbles 43 (see FIG. 8) to be generated by the application of the concentrated laser beam 31 can be suppressed, and hence the region to be irradiated with scattered light 38 can be restricted.

FIG. 8 is a fragmentary cross-sectional view depicting an irradiation region in the related art as a comparative example. In the comparative example, a film of the liquid 41 has a sufficiently large thickness 42 compared with the embodiment. If the film of the liquid 41 that covers the irradiation region 37 of the workpiece 100 is large as in the comparative example, the bubbles 43 generated by the application of the concentrated laser beam 31 rise in the liquid 41. This increases a region to be irradiated with scattered light 38 caused by the bubbles 43, so that the scattered light 38 from the concentrated laser beam 31 may be applied to a location apart from a desired processing point.

If the pressure at which the liquid 41 is ejected from the liquid ejection nozzle 40 is sufficiently high, the film of the liquid 41 becomes smaller than the ejection diameter 74. If the pressure is excessively high, on the other hand, the film of the liquid 41 becomes unstable due to turbulence. It is therefore preferred to appropriately control the distance of ejection, the ejection diameter 74, and the nozzle pressure.

The present assignee validated conditions of a laser processed groove 106 and scattered light damages 107 by performing laser groove processing on films of the liquid 41 formed by the liquid ejection nozzle 40 in the above-described embodiment. Laser processing conditions were similar to those in the above-mentioned laser beam irradiation step 203 in the embodiment.

First, the nozzle pressure (a control value for the pressure by the pump 90) at the liquid ejection nozzle 40 was varied, and at the respective varied nozzle pressures, the conditions of the laser processed groove 106 and the scattered light damages 107 were validated. In the validation, the distance in the axial direction from the orifice 64 of the liquid ejection nozzle 40 to the front surface 102 of the workpiece 100 was set to 10 mm, and the ejection diameter 74 of the liquid ejection nozzle 40 was set to 100 μm in diameter. As the nozzle pressure, 10 patterns of 0.5 MPa, 0.6 MPa, 0.8 MPa, 0.9 MPa, 1.0 MPa, 1.1 MPa, 1.2 MPa, 1.3 MPa, 1.4 MPa, and 1.5 MPa were validated.

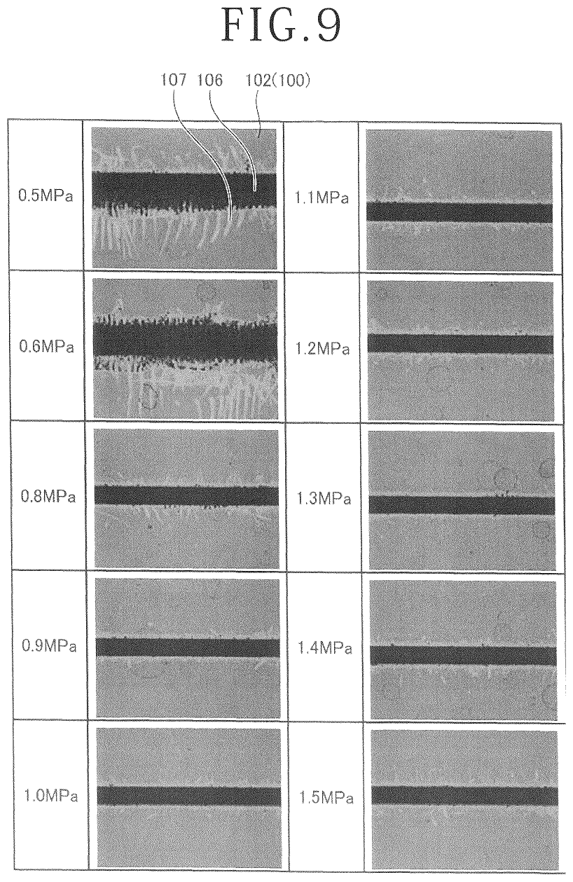

FIG. 9 contains images presenting empirical results on the laser processed groove 106 and the scattered light damages 107 corresponding to the varied pressures at the liquid ejection nozzle 40. As presented in FIG. 9, a large number of the scattered light damages 107 are present also at locations apart from the laser processed groove 106 when the laser processed groove 106 was formed by applying the concentrated laser beam 31 through a thin film of the liquid 41 as formed by ejecting the liquid 41 at 0.5 MPa or 0.6 MPa. Further, unclear boundaries are seen between the laser processed groove 106 and its surrounding regions, and the laser processed groove 106 is seen to have a non-uniform width.

When the liquid 41 was ejected at 0.8 MPa, the width of the laser processed groove 106 is substantially uniform, but there are still unclear parts at the boundaries between the laser processed groove 106 and its surrounding regions. Further, the scattered light damages 107 are seen at locations apart from the laser processed groove 106.

When the liquid 41 was ejected at 0.9 MPa or 1.0 MPa, the width of the laser processed groove 106 is substantially uniform, and the boundaries between the laser processed groove 106 and its surrounding regions are clear. Further, at locations apart from the laser processed groove 106, a smaller number of the scattered light damages 107 than those seen when the liquid 41 was ejected at 0.8 MPa are seen.

When the liquid 41 was ejected at 1.1 MPa or 1.2 MPa, the width of the laser processed groove 106 is substantially uniform, and the boundaries between the laser processed groove 106 and its surrounding regions are clear. However, at locations apart from the laser processed groove 106, a slightly larger number of the scattered light damages 107 than those seen when the liquid 41 was ejected at 0.9 MPa or 1.0 MPa are seen.

When the liquid 41 was ejected at 1.3 MPa, the laser processed groove 106 is seen to have a substantially uniform width, and a smaller number of the scattered light damages 107 than those seen when the liquid 41 was ejected at 1.1 MPa or 1.2 MPa are seen at locations apart from the laser processed groove 106. However, there are still unclear parts at the boundaries between the laser processed groove 106 and its surrounding regions.

When the liquid 41 was ejected at 1.4 MPa or 1.5 MPa, the width of the laser processed groove 106 is substantially uniform, and the boundaries between the laser processed groove 106 and its surrounding regions are clear. However, at locations apart from the laser processed groove 106, a larger number of the scattered light damages 107 than those seen when the liquid 41 was ejected at 1.3 MPa are seen.

From the foregoing results, it has been found preferable to control the nozzle pressure to set it to approximately 0.9 MPa or higher and 1.0 MPa or lower if the distance in the axial direction from the orifice 64 of the liquid ejection nozzle 40 to the front surface 102 of the workpiece 100 is 10 mm and the ejection diameter 74 of the liquid ejection nozzle 40 is 100 μm in diameter. It can hence be gathered that, if the nozzle pressure is excessively low, the film of the liquid 41 is not formed with a sufficiently small thickness, the generated bubbles 43 rise in the liquid 41, and the scattered light damages 107 by the scattered light 38 cannot be suppressed sufficiently, and also that, if the nozzle pressure is excessively high, on the other hand, the film of the liquid 41 becomes unstable due to turbulence.

Next, the ejection diameter 74 of the liquid ejection nozzle 40 was varied, and at the respective varied ejection diameters 74, the conditions of the laser processed groove 106 and the scattered light damages 107 were validated. By varying the ejection diameter 74, the thickness 42 of the thin film of the liquid 41 to be formed can be varied. The thickness 42 of the thin film of the liquid 41 is substantially equal to the ejection diameter 74. In the validation, the distance in the axial direction from the orifice 64 of the liquid ejection nozzle 40 to the front surface 102 of the workpiece 100 was set to 10 mm, and the nozzle pressure was set to 1.0 MPa. As the ejection diameter 74 of the liquid ejection nozzle 40, two patterns of 100 μm in diameter and 50 μm in diameter were validated.

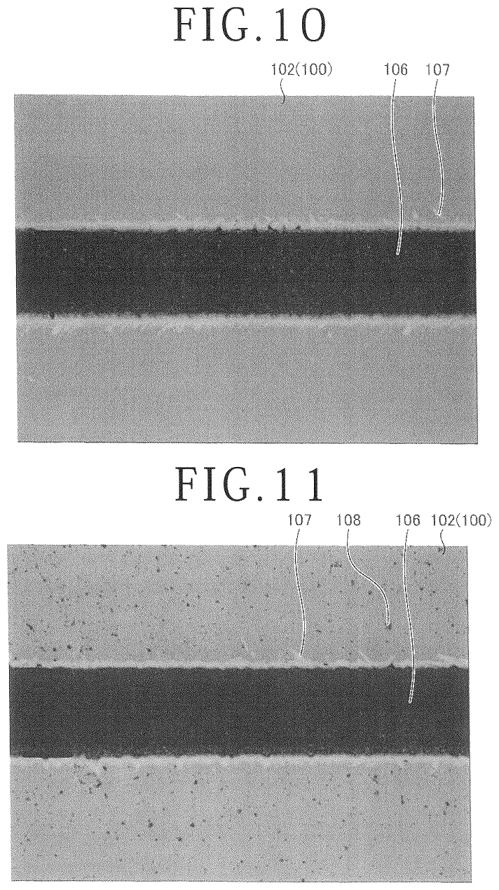

FIGS. 10 and 11 each contain an image presenting empirical results on the laser processed groove 106 and the scattered light damages 107 corresponding to the varied ejection diameter 74 of the liquid ejection nozzle. FIG. 10 presents the empirical results at the ejection diameter 74 of the liquid ejection nozzle 40 of 100 μm in diameter, and FIG. 11 presents the empirical results at the ejection diameter 74 of 50 μm in diameter.

As presented in FIG. 10, when the liquid 41 was ejected at the ejection diameter 74 of 100 μm in diameter, the width of the laser processed groove 106 is substantially uniform, and the boundaries between the laser processed groove 106 and its surrounding regions are clear. Although the scattered light damages 107 are present on both sides in a direction of the groove width of the laser processed groove 106, a small number of the scattered light damages 107 are seen at locations apart from the laser processed groove 106.

As presented in FIG. 11, when the liquid 41 was ejected at the ejection diameter 74 of 50 μm in diameter, many pieces of the debris 108 are seen stuck around the laser processed groove 106. Further, some unclear parts are seen at the boundaries between the laser processed groove 106 and its surrounding regions, but the laser processed groove 106 is seen to have a substantially uniform width.

Next, the liquid 41 was formed into films of greater thicknesses as in the method of the related art, and the conditions of the laser processed groove 106 and the scattered light damages 107 at the respective thicknesses were validated. In the validation, the thicknesses of the films of the liquid 41 were set to 3 mm, 2 mm, and 1 mm.

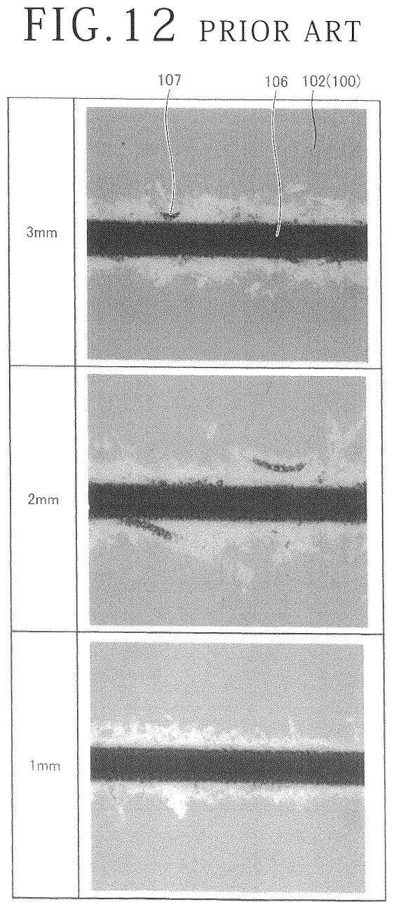

FIG. 12 contains images presenting empirical results on the laser processed groove 106 and the scattered light damages 107 in the related art as a comparative example. As depicted in FIG. 12, a large number of the scattered light damages 107 are seen from both sides in the direction of the groove width of the laser processed groove 106 to locations remote from these sides.

Based on a comparison among FIGS. 10, 11, and 12, it has been found that the scattered light damages 107 can be suppressed by reducing the thickness of the film of the liquid 41. It is therefore possible to gather that, by reducing the thickness of the film of the liquid 41, the rise of the bubbles 43 is suppressed and the scattered light damages 107 caused by the scattered light 38 due to the bubbles 43 are also suppressed.

Based on a comparison between FIG. 10 and FIG. 11, it has also been found that the debris 108 sticks the front surface 102 of the workpiece 100 if the ejection diameter 74 of the liquid ejection nozzle 40 is made smaller. It is therefore possible to gather that, if the ejection diameter 74 is made excessively small, the thin film of the liquid 41 is not appropriately formed at some locations, and the debris 108 sticks there. Even if the ejection diameter 74 is small, the thickness 42 of the thin film of the liquid 41 can be increased by lowering the nozzle pressure. It is therefore preferred to comprehensively control the distance in axial direction from the liquid ejection nozzle 40 to the front surface 102 of the workpiece 100 and the ejection diameter 74 and the nozzle pressure of the liquid ejection nozzle 40.

As has been described above, the laser processing machine 1 of this embodiment and the laser processing method of this embodiment can restrict the region to be irradiated with the scattered light 38 caused by the bubbles 43 which are generated by the application of the concentrated laser beam 31, by making thinner the film of the liquid 41 to be formed over the upper surface (front surface 102) of the workpiece 100. The laser processing machine 1 of this embodiment and the laser processing method of this embodiment can therefore exhibit an advantage that the quality of devices 104 can be suppressed from being lowered due to the scattered light 38.

The present invention should not be limited to the above-described embodiment. For example, the laser irradiation unit 30 may have a galvano mirror instead of the polygonal mirror 36, or may omit a scanner unit such as the polygonal mirror 36 or a galvano mirror.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing machine for forming grooves or perforations in a workpiece from one side thereof, the laser processing machine comprising:
a holding unit that holds the workpiece at the other side thereof opposite to the one side to have the one side exposed;
a laser irradiation unit having a laser oscillator that emits a laser beam and a condenser that concentrates the laser beam and irradiates the workpiece with the concentrated laser beam; and
a liquid ejection nozzle that ejects liquid to an irradiation region where the workpiece is to be irradiated with the concentrated laser beam on the one side thereof, to form a thin film of the liquid over the irradiation region,
wherein the workpiece is irradiated with the concentrated laser beam through the thin film of the liquid.

2. The laser processing machine according to claim 1, wherein the liquid ejection nozzle has an ejection diameter of 100 μm or smaller to eject the liquid.

3. The laser processing machine according to claim 2, wherein the liquid ejection nozzle has an ejection diameter of 50 μm or greater to eject the liquid.

4. A laser processing method for forming grooves or perforations in a workpiece from one side thereof, the laser processing method comprising:
a holding step of holding the workpiece at the other side thereof opposite to the one side to have the one side exposed;
a liquid thin film forming step of ejecting liquid to the one side of the workpiece to form a thin film of the liquid; and
a laser beam irradiation step of emitting a laser beam, concentrating the laser beam, and then irradiating the workpiece at the one side thereof with the concentrated laser beam through the thin film of the liquid.

5. The laser processing method according to claim 4, wherein, in the liquid thin film forming step, the thin film of the liquid is formed with a thickness of 100 μm or smaller.

6. The laser processing method according to claim 5, wherein, in the liquid thin film forming step, the thin film of the liquid is formed with a thickness of 50 μm or greater.
